(19) United States
(12) Patent Application Publication
(10) Pub. No.: US 2012/0215788 A1
(43) Pub. Date: Aug. 23, 2012

(54) Data Processing

(75) Inventor: Juha Petteri Ojanpera, Nokia (FI)

(73) Assignee: NOKIA CORPORATION, Espoo (FI)

(21) Appl. No.: 13/505,448

(22) PCT Filed: Nov. 18, 2009
(86) PCT No.: PCT/EP2009/065429

§ 371 Date: May 1, 2012

(51) Int. Cl. G06F 17/30

(52) U.S. Cl. 707/741; 707/E17.002

(57) ABSTRACT

A method comprising: receiving sample data for a plurality of channels, wherein the sample data comprises a plurality of separate sample values and each sample value may be identified using at least a channel index that differentiates between channels and a sampling index that differentiates between sample values; performing energy compaction with respect to at least one of the channel indexes and the sampling indexes to create compacted sample values where each compacted sample value may be identified using at least a channel index that differentiates between channels and a sampling index that differentiates between sample values; and selecting some but not all of the compacted sample values for further program.

### FIELD OF THE INVENTION

Embodiments of the present invention relate to data processing. In particular, some embodiments relate to sparse sampling.

### BACKGROUND TO THE INVENTION

In communications engineering there is a pervasive problem. Typically a communication channel has a maximum bandwidth and it is important that this bandwidth is used efficiently. For example, it is now common practice to apply compression algorithms to reduce bandwidth. However, the algorithms have only limited use and application. They may, for example, an algorithm may operate efficiently at intra-channel compression but less efficiently at inter-channel compression.

It would be desirable to have technology that is capable of transmitting data from a number of input channels over a communication channel in such a way that the perceptual quality of the data when received is satisfactory.

### BRIEF DESCRIPTION OF VARIOUS EMBODIMENTS OF THE INVENTION

According to various, but not necessarily all, embodiments of the invention there is provided a method comprising receiving sample data for a plurality of channels, wherein the sample data comprises a plurality of separate sample values and each sample value may be identified using at least a channel index that differentiates between channels and a sampling index that differentiates between sample values; performing energy compaction with respect to at least one of the channel indexes and the sampling indexes to create compacted sample values where each compacted sample value may be identified using at least a channel index that differentiates between channels and a sampling index that differentiates between sample values; and selecting some but not all of the compacted sample values for further processing.

According to various, but not necessarily all, embodiments of the invention there is provided an apparatus comprising: circuitry configured to store sample data for a plurality of channels, wherein the sample data comprises a plurality of separate sample values and each sample value may be identified using at least a channel index that differentiates between channels and a sampling index that differentiates between sample values; compaction circuitry configured to perform energy compaction with respect to at least one of the channel indexes and the sampling indexes to create compacted sample values where each compacted sample value may be identified using at least a channel index that differentiates between channels and a sampling index that differentiates between sample values; and circuitry configured to provide selected ones of the compacted sample values for further processing.

According to various, but not necessarily all, embodiments of the invention there is provided an apparatus comprising: means for receiving sample data for a plurality of channels, wherein the sample data comprises a plurality of separate sample values and each sample value may be identified using at least a channel index that differentiates between channels and a sampling index that differentiates between sample values; means for performing energy compaction with respect to at least one of the channel indexes and the sampling indexes to create compacted sample values where each compacted sample value may be identified using at least a channel index that differentiates between channels and a sampling index that differentiates between sample values; and means for selecting some but not all of the compacted sample values for further processing.

According to various, but not necessarily all, embodiments of the invention there is provided a computer program which when loaded into a processor enables the processor to: access sample data for a plurality of channels, wherein the sample data comprises a plurality of separate sample values and each sample value may be identified using at least a channel index that differentiates between channels and a sampling index that differentiates between sample values; perform energy compaction with respect to at least one of the channel indexes and the sampling indexes to create compacted sample values where each compacted sample value may be identified using at least a channel index that differentiates between channels and a sampling index that differentiates between sample values; and select some but not all of the compacted sample values for further processing.

According to various, but not necessarily all, embodiments of the invention there is provided a method comprising receiving a plurality of compacted sample values in a format where each compacted sample value may be identified using at least a channel index that differentiates between channels and a sampling index that differentiates between sample values; and performing energy de-compaction with respect to at least one of the channel indexes and the sampling indexes to create sample values where each sample value may be identified using at least a channel index that differentiates between channels and a sampling index that differentiates between sample values.

According to various, but not necessarily all, embodiments of the invention there is provided an apparatus comprising: circuitry configured to receive a plurality of compacted sample values in a format where each compacted sample value may be identified using at least a channel index that differentiates between channels and a sampling index that differentiates between sample values; and de-compaction circuitry configured to perform energy compaction with respect to at least one of the channel indexes and the sampling indexes to create sample values where each sample value may be identified using at least a channel index that differentiates between channels and a sampling index that differentiates between sample values.

According to various, but not necessarily all, embodiments of the invention there is provided an apparatus comprising means for receiving a plurality of compacted sample values in a format where each compacted sample value may be identified using at least a channel index that differentiates between channels and a sampling index that differentiates between sample values; and means for performing energy de-compaction with respect to at least one of the channel indexes and the sampling indexes to create sample values where each sample value may be identified using at least a channel index that differentiates between channels and a sampling index that differentiates between sample values.

According to various, but not necessarily all, embodiments of the invention there is provided a computer program which when loaded into a processor enables the processor to: access compacted sample values where each compacted sample value may be identified using at least a channel index that differentiates between channels and a sampling index that differentiates between sample values; and perform energy de-compaction with respect to at least one of the channel indexes and the sampling indexes to create sample values where each sample value may be identified using at least a channel index that differentiates between channels and a sampling index that differentiates between sample values.

According to various, but not necessarily all, embodiments of the invention there is provided a communication device comprising: reception circuitry for receiving processed, selected compacted sample values; processing circuitry for further processing the processed, selected compacted sample values to recover the selected compacted sample values; and an apparatus as claimed in any one of claims 49 to 52 for estimating the sample values from the selected compacted sample values.

Some embodiments of the invention may therefore greatly reduce the required transmission bandwidth (data rate) or storage space while maintaining satisfactory perceptual quality.

### BRIEF DESCRIPTION OF THE DRAWINGS

For a better understanding of various examples of embodiments of the present invention reference will now be made by way of example only to the accompanying drawings in which:

FIG. 1 schematically illustrates a communication system;

FIG. 2 schematically illustrates a method;

FIG. 3A schematically illustrates an ordered arrangement of sampling values;

FIG. 3B schematically illustrates an ordered multi-dimensional arrangement of compacted sample values;

FIG. 4 schematically illustrates pre-processing of sampling values;

FIG. 5A schematically illustrates an example of energy compaction;

FIG. 5B schematically illustrates an example of energy compaction;

FIG. 6 schematically illustrates an example of a transmitting device;

FIG. 7 schematically illustrates an example of a transmitting device;

FIG. 8 schematically illustrates another example of a transmitting device;

FIG. 9A schematically illustrates another example of a receiving device;

FIG. 9B schematically illustrates another example of a receiving device;

FIG. 10 schematically illustrates an ordered three-dimensional arrangement of compacted sample values;

FIG. 11 schematically illustrates a sampling grid; and

FIG. 12 schematically illustrates a system.

### DETAILED DESCRIPTION OF VARIOUS EMBODIMENTS OF THE INVENTION

The Figures illustrate a sparse sampling methodology. Sample data 7 for a plurality of channels are converted to sparsely sampled data 9. The sample data 7 comprises a plurality of separate sample values 46 and each sample value 46 may be uniquely identified using at least an input channel index 42 that differentiates between channels and a sampling index 44 that differentiates between sample values. Energy compaction 34 is performed with respect to at least one of the channel indexes 42 and the sampling indexes 44 to create compacted sample values 56. Each compacted sample value 56 may be uniquely identified using at least a channel index 52 that differentiates between channels and a sampling index 54 that differentiates between compacted sample values. Some but not all of the compacted sample values 56 are then selected 36 as sparse sampled values 9 for further processing. This sparse sampling greatly reduces the data rate without adverse compromising quality.

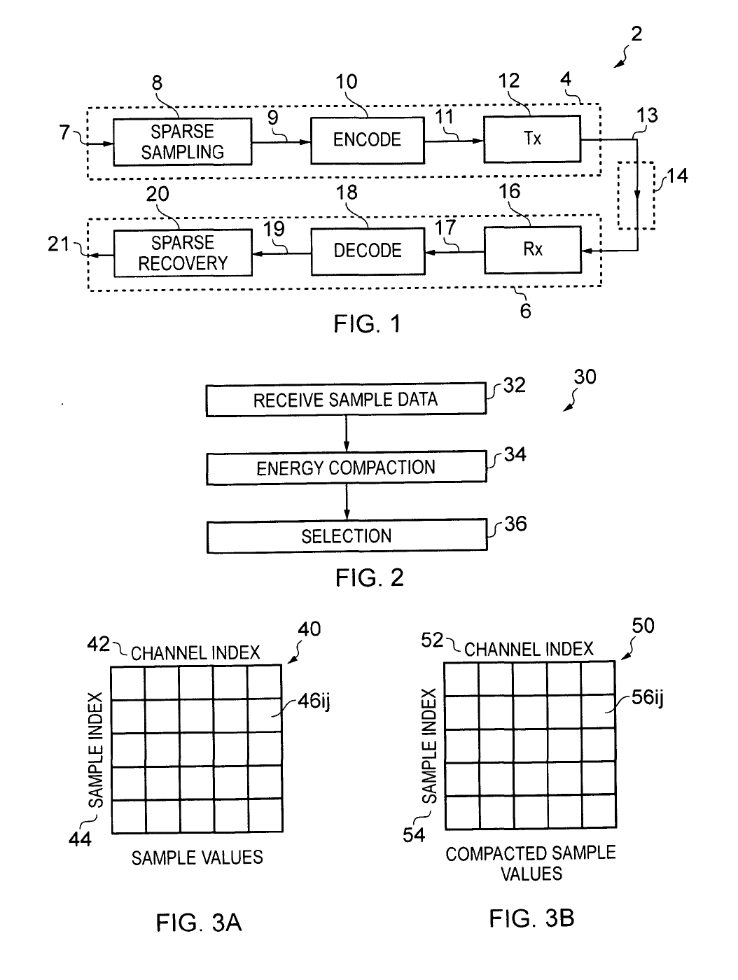

FIG. 1 schematically illustrates an example of a communication system 2.

This communication system 2 comprises a transmitting device 4 and a receiving device 6 which communicate via a communications channel 14.

The transmitting device 4 may be any suitable apparatus or collection of apparatuses. It may, for example, be a hand-portable device or a desk-top device. It may have additional functions beside communication via the communications channel 14.

The receiving device 6 may be any suitable apparatus or collection of apparatuses. It may, for example, be a hand-portable device or a desk-top device. It may have additional functions beside communication via the communications channel 14.

The communications channel may use physical infrastructure such as optical fibers or wires and/or may operate wirelessly via for example, short range communication protocols such as Bluetooth, wireless universal serial bus (WUSB), wireless local area network (WLAN) etc or longer range communication protocols such as cellular wireless protocols.

The transmitting device 4 takes sample values 7 and performs sparse sampling at block 8 to produce sparse sampled values 9. The sparse sampling block 8 may be performed entirely in hardware, entirely in software or in a combination of hardware and software.

In this example, further processing of the sparse sampled values 9 involves encoding and then transmission via the communications channel 14. In other implementations additional or different further processing may occur.

An encoding block 10 encodes the sparse sampled values 9 to produce encoded sparse sampled values 11. The encoding block 10 may be performed entirely in hardware, entirely in software or in a combination of hardware and software.

Next the transmission block 12 transmits the sparse sampled values 9 in the communications channel 14 as a transmitted signal 13. The transmission block 12 may be performed entirely in hardware, or in a combination of hardware and software.

The receiving device 6 takes the transmitted signal 13 and produces as output 21 estimates of the original sample values 7.

A reception block 16 receives the transmitted signal 13 and generates recovered encoded sparse sampled values 17. The reception block 16 may be performed entirely in hardware, or in a combination of hardware and software.

A decoding block 18 decodes the recovered encoded sparse sampled values 17 to produce recovered sparse sampled values 19. The decoding block 18 may be performed entirely in hardware, entirely in software or in a combination of hardware and software.

A sparse recovery block 20 performs sparse recovery on the recovered sparse sampled values 19 to produce as output 21 estimates of the original sample values 7. The sparse recovery block 20 may be performed entirely in hardware, entirely in software or in a combination of hardware and software.

FIG. 2 schematically illustrates a method 30 in which sample values 7 are sparsely sampled. This method may, for example, be performed by the sparse sampling block 8.

FIG. 3A schematically illustrates an ordered multi-dimensional arrangement 40 of sample values 7. Each individual sample value 46 may be uniquely identified using two indexes—a channel index 42 that differentiates between channels and a sampling index 44 that differentiates between sample values.

According to FIG. 2, the method 30 starts at block 32 where sample data for a plurality of channels is received. The sample data comprises a plurality of separate sample values. Each sample value 7 may be identified using at least the channel index 42 and the sampling index 44.

Next at block 34, energy compaction of the sample values 7 with respect to at least one of the channel indexes and the sampling indexes is performed to create compacted sample values 56.

FIG. 3B schematically illustrates an ordered multi-dimensional arrangement 50 of compacted sample values 56. Each compacted sample value 56 may be uniquely identified using two indexes—a channel index 52 that differentiates between channels and a sampling index 54 that differentiates between compacted sample values.

The channel index 52 may be equivalent to the channel index 42. The sample index 54 may be equivalent to the sample index 44.

Energy compaction comprises concentration of energy to a sub-set of a plurality of indexes. For example, concentration to a sub-set of the channel indexes and/or to a sub-set of the sample indexes.

Next at block 36, a sub-set of the compacted sample values 56 are selected for further processing. The selected sub-set comprises some but not all of the compacted sample values 56.

This selection greatly reduces the data rate and the energy compaction before selection maintains quality.

The sub-set of the compacted sample values 56 may be selected by selecting a sub-set of the sample indexes. For example, those indexes that represent the perceptually most important samples may be selected. Perceptual importance may, for example, be assessed by calculating a cumulative energy over multiple channels for a sample index. The determination of perceptual importance may, for example, be carried out over all the channels associated with an index or over only some, the most perceptually important, channels associated with an index.

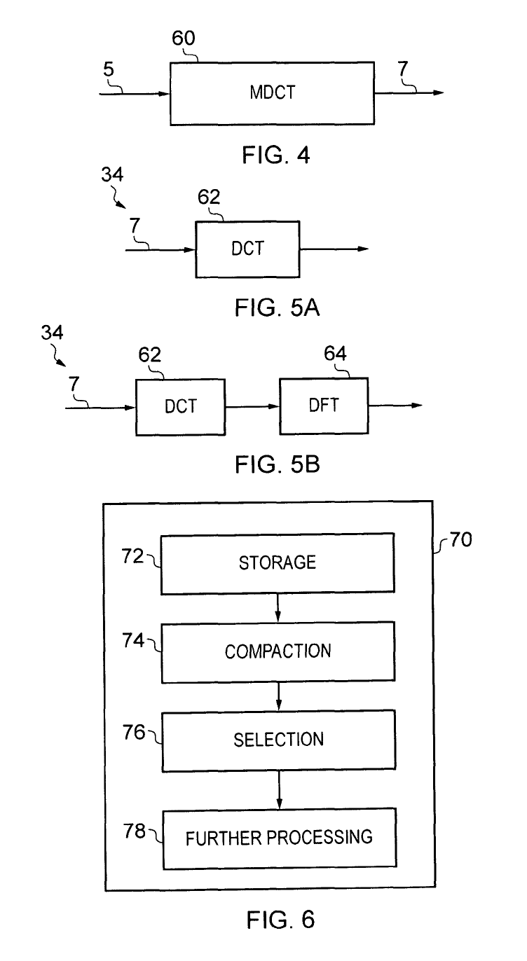

FIG. 4 schematically illustrates optional pre-processing of sampling values 7. A modified discrete cosine transform block 60 is used to process sample data 5 and convert the sample values 7 from time domain to frequency domain.

FIG. 5A schematically illustrates an example of energy compaction of the sample values 7. In this example, a discrete cosine transform (DCT) block 62 performs energy compaction of the sample values 7 with respect the channel indexes 42 and/or the sampling indexes 44 to create compacted sample values 56.

FIG. 5B schematically illustrates an example of energy compaction of the sample values 7. In this example, a discrete cosine transform (DCT) block 62 operates on the sample values 7. The transform is performed with respect to the channel indexes 42 and/or the sampling indexes 44. The values output by the DCT block 62 are then operated on by a discrete Fourier transform (DFT) block 64. The DFT enables quantization of correlation. The DFT block 64 operates on the DCT transformed sample values to create compacted sample values 56. The transform is performed with respect to the channel indexes 42 and/or the sampling indexes 44.

FIG. 6 schematically illustrates an example 70 of a transmitting device 4.

The transmitting device is illustrated as a number of separate blocks 72, 74, 76, 78

The blocks in this example include storage circuitry block 72, compaction circuitry block 74, selection circuitry block 76 and further processing circuitry block 78.

The storage circuitry block 72 is configured to store the sample values 7. They may be stored in a format that records an ordered multi-dimensional arrangement 40 such as that illustrated in FIG. 3A. This type of arrangement 40 allows each individual sample value 46 to be uniquely referenced using a channel index 42 and a sampling index 44.

The compaction circuitry block 74 is configured to perform energy compaction with respect to at least one of the channel indexes 42 and the sampling indexes 44 to create compacted sample values 56. Each compacted sample value 56 may be identified using at least a channel index 52 that differentiates between channels and a sampling index 54 that differentiates between sample values.

The selection circuitry block 76 is configured to select some but not all of the compacted sample values 56 for further processing and to provide the selected ones of the compacted sample values 56 for further processing in the further processing circuitry block 78. This further processing may, for example include encoding and transmission as illustrated in FIG. 1.

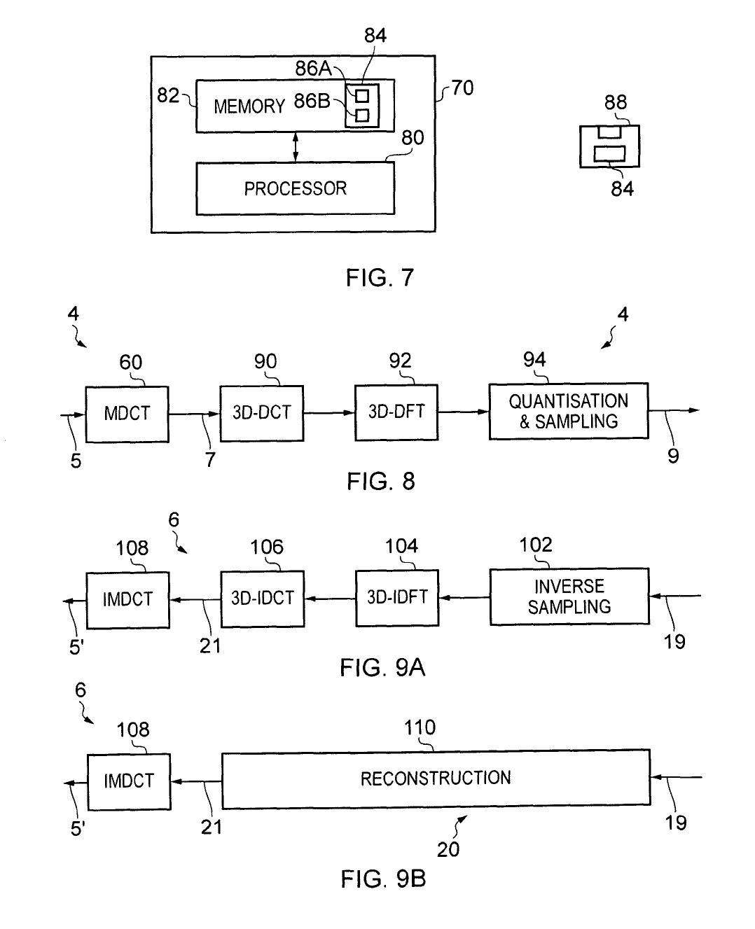

Each circuitry block 72, 74, 76, 78, in this embodiment, represents circuitry for performing a specified function. Each block may represent a discrete specialized circuit for performing only the specified function. Alternatively, a generalized circuit may perform more than one of the specified functions and a block may represent the generalized circuit as it performs a particular specialized function. The generalized circuit may, for example, be a general purpose processor 80 as illustrated in FIG. 7 that runs a first computer program code 86A loaded from a memory 82 to operate as the compaction circuitry block 74 and runs second computer program code 86B loaded from memory 82 to operate as the selection circuitry block 76. In the illustrated example, the processor 80 is configured to read from and write to the memory 82 which stores a computer program 84 including the first computer program code 86A and the second computer program code 86B.

The memory 82 provides means for receiving sample data for a plurality of channels, wherein the sample data comprises a plurality of separate sample values 7 and each sample value 46 may be identified using at least a channel index 42 that differentiates between channels and a sampling index 44 that differentiates between sample values.

The first computer code 86A provides, when loaded into the processor 80, means for performing energy compaction with respect to at least one of the channel indexes 42 and the sampling indexes 44 to create compacted sample values 56 (FIG. 3B) where each compacted sample value 46 may be identified using at least a channel index 52 that differentiates between channels and a sampling index 54 that differentiates between compacted sample values.

The second computer code 86B provides, when loaded into the processor 80, means for selecting some but not all of the compacted sample values 56 for further processing.

The computer program 84 may arrive at the apparatus 70 via any suitable delivery mechanism 88. The delivery mechanism 88 may be, for example, a computer-readable storage medium, a computer program product, a memory device, a record medium, or an article of manufacture that tangibly embodies the computer program. The delivery mechanism may be a signal configured to reliably transfer the computer program.

Although the memory 82 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

Referring back to FIG. 1, the receiving apparatus 6 receives a selected plurality of compacted sample values in a format where each compacted sample value may be identified using at least a channel index that differentiates between channels and a sampling index that differentiates between sample values.

The sparse recovery block 20 performs energy de-compaction with respect to at least one of the channel indexes and the sampling indexes to create sample values where each sample value may be identified using at least a channel index that differentiates between channels and a sampling index that differentiates between sample values. The energy de-compaction comprises distribution of energy from a sub-set of a plurality of indexes and may include performing an inverse discrete cosine transform or an inverse discrete Fourier transform followed by a inverse discrete cosine transform.

FIG. 8 schematically illustrates another example of a transmitting device 4 similar to that illustrated in FIG. 1. However, this transmitting device 4 includes the optional pre-processing of sampling values 7 by a modified discrete cosine transform (MDCT) block 60. Furthermore, the sparse sampling block 8 is illustrated in more detail. In addition, particular further processing is not illustrated. The further processing for this transmitting device 4 may be the same or different to that of the transmitting device 4 illustrated in FIG. 1.

FIG. 2 schematically illustrates a method 30 in which sample values 7 are sparsely sampled. This method may, for example, be performed by the sparse sampling block 8 illustrated in FIG. 8.

In this example, each individual sample value 46 may be uniquely identified using three indexes—a channel index 42 that differentiates between channels, a sampling index 44 that differentiates between sample values and a frame index that differentiates between frames.

According to FIG. 2, the method 30 starts at block 32 where sample data for a plurality of channels is received after pre-processing by the MDCT block 60. The sample data comprises a plurality of separate sample values. Each sample value 7 may be uniquely identified using a combination of a channel index 42, a sampling index 44 and a frame index.

Next at block 34, energy compaction of the sample values 7 with respect to at least one of the channel indexes and the sampling indexes is performed to create compacted sample values 56.

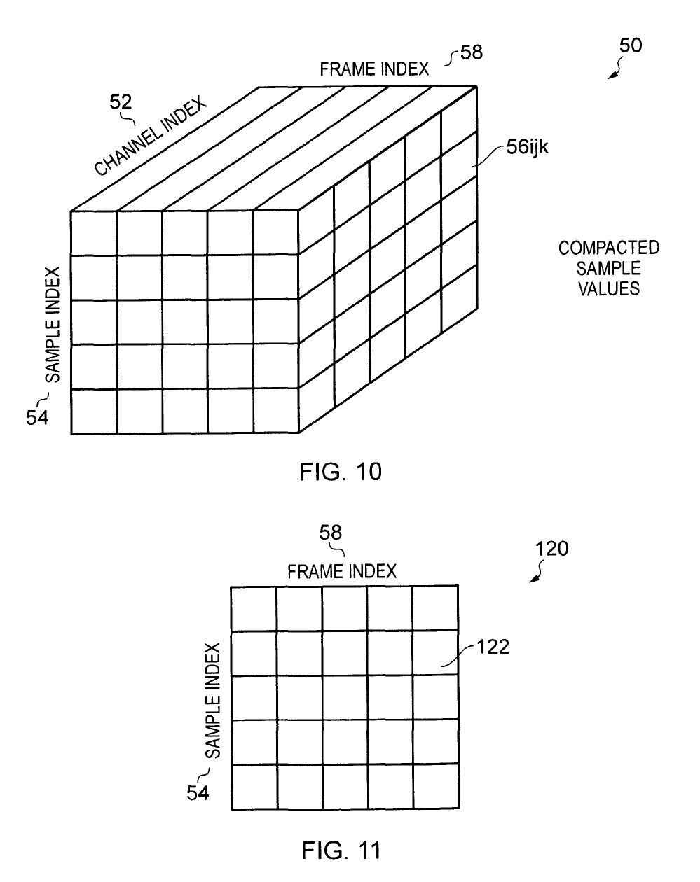

FIG. 10 schematically illustrates an ordered multi-dimensional arrangement 50 of compacted sample values 56. Each compacted sample value 56 may be uniquely identified using a combination of three indexes—a channel index 52 that differentiates between channels, a sampling index 54 that differentiates between compacted sample values, and a frame index 58 that differentiates between frames.

The channel index 52 may be equivalent to the channel index 42. The sample index 54 may be equivalent to the sample index 44.

Energy compaction comprises concentration of energy to a sub-set of a plurality of indexes. In this example, compaction occurs with respect to a sub-set of the channel indexes and to a sub-set of the sample indexes and to a sub-set of the frame indexes.

Referring back to FIG. 8, energy compaction is performed by the serial arrangement of the three dimensional discrete cosine transform (3D-DCT) block 90 and the three dimensional discrete Fourier transform (3D-DFT) block 92.

Next at block 36 of FIG. 2, a sub-set of the compacted sample values 56 are selected for further processing. The selected sub-set comprises some but not all of the compacted sample values 56. This selection greatly reduces the data rate and the energy compaction before selection maintains perceptual quality.

Referring back to FIG. 8, selection is performed by the quantization and sampling block 94.

The operation of the transmitting apparatus 4 illustrated in FIG. 8 will now be described in more detail using a specific example.

In the MDCT block 60, each channel of the multi-channel input signal 5 is first transformed to a frequency representation 7. A time-frequency (TF) operator is applied to each signal frame according to

Xₘ[k,l]=TF(x_{m,l,t}) (1)

where m is the channel index, k is the frequency bin index (sample index), l is a time frame index, T is the hop size between successive analysis frames, and TF( ) the time-to-frequency operator. In an example embodiment of the invention, MDCT is used as the TF operator, for example as follows

$$TF ( {x}_{m , l , T} ) = 2 \cdot {\sum }_{n = 0}^{N - 1} {x}_{i n} ( n ) \cdot cos ( \frac{2 \cdot π}{N} \cdot ( n + \frac{N}{4} + 0.5 ) \cdot ( k + 0.5 ) ) , \\ 0 \leq k < \frac{N}{2} - 1 \\ {x}_{i n} ( n ) = w ( n ) \cdot {x}_{m} ( n + l \cdot T ) \qquad ( 2 )$$

where w(n) is a N-point analysis window that defines an analysis frame, such as sinusoidal or Kaiser-Bessel Derived (KBD) window. In MDCT, the hop size T=N/2.

The 3D-DCT block 90 applies a one-dimensional DCT separately to each dimension of the three dimensional matrix 50 according to

Y^{3D}[d,k,d=dct(Y_{0, . . . , M-1}[k,t]), Yₘk,t]=dct(F_{row-wise})_{column-wise)}

F=Xₘ[k,u], t_start≦u<t_end

t_start=grpIdx·TF_size

t_end=t_start+TF_size

grpIdx=0,1,2,3, (3)

where m is a channel index, k is a sample index and grpIdx is a frame index and where dct( ) function calculates one-dimensional DCT and TF_size is the size of the two-dimensional (2D) time-frequency plane as number of analysis frames. The size of matrix Y^{3D} is therefore M×TF_size×A where M is the number of channels in the multi-channel input signal, and A is the number of frequency bins in an analysis frame, which in this example embodiment of the invention equals to N/2.

In one embodiment of the invention, the value of TF_size may be set to 64, while other embodiments may use different values. In Equation (3), the 3D-DCT domain representation is thus obtained by grouping a set of successive frequency domain frames and applying one-dimensional DCT first to each row of the grouped frames, and then to the columns of the result. In other words, first a DCT transform is applied to a number of vectors, each vector representing an analysis frame in F, followed by a second DCT transform applied to a number of (transformed) vectors, each vector representing values of certain frequency bin (across frames) in F As an alternative, the order of DCT transforms may be exchanged, i.e. to first apply a DCT vectors representing values of certain frequency bin, followed by a DCT applied to (transformed) vectors, each vector corresponding to an analysis frame.

Finally, one-dimensional DCT is applied to vectors formed by taking respective entries of each of the 2D-DCT matrixes, each such vector covering (transformed) values of a certain frequency bin in a certain analysis frame across all channels of the input signal, to get the 3D output 50 (FIG. 10). Furthermore, the one-dimensional DCT of a vector x (of length N) may be calculated according to

$$X [ k ] = \frac{2}{N} \cdot C ( k ) \cdot {\sum }_{n = 0}^{N - 1} x ( n ) \cdot cos [ \frac{π \cdot k}{2 \cdot N} \cdot ( 2 \cdot n + 1 ) ] \\ C ( i ) = \{ \begin{matrix}\frac{1}{\sqrt{2}} , & i == 0 \\ 1 , & otherwise\end{matrix} \qquad ( 4 )$$

where X={X₀, . . . X_{N-1}} is the DCT transformed sequence.

The 3D-DFT block 92 then applies a 3D-DFT transform to the matrix Y^{3D}. The 3D-DFT is calculated by applying one-dimensional DFT separately to each dimension of the matrix according to

Z[m,k,f]=dft_{m,k,f}(Y^{3D}) (5)

where dft_{m,k,f}( ) function calculates one-dimensional DFT in each specified dimension; in this case m, k, and f dimensions where m is the channel index, k is the sample index and f id the frame index.

Furthermore, the one-dimensional DFT of a vector x (of length N) may be calculated according to

$$X [ k ] = {\sum }_{n = 0}^{N - 1} ( x [ n ] \cdot {e}^{- j \cdot {w}_{k} \cdot n} ) \qquad ( 6 )$$

where

$${w}_{k} = \frac{2 \cdot π \cdot k}{N}$$

and X={X₀, . . . X_{N-1}} is the DFT transformed sequence.

The quantization and sampling block 94 first produces a sampling grid 120 as illustrated in FIG. 11. This sampling grid 120 is used to guide sparse sampling.

The sampling grid 120 is defined by sampling indexes 54 and frame indexes 58, from a plurality of quantized consolidated compacted sample values 122. Quantized values in this context may refer to zeros and ones in the sampling grid 120.

Each quantized consolidated compacted sample value 122 is formed by summing at least some of the compacted sample values 56 that have the same sample index 54 and frame index 58 but different channel indexes 52.

In one embodiment, each consolidated compacted sample value is formed by summing all of the compacted sample values 56 that have the same sample index 54 and frame index 58 but different channel indexes 52.

In another alternative embodiment, each consolidated compacted sample value is formed by summing selected ones of the compacted sample values 56 that have the same sample index 54 and frame index 58 but different channel indexes 52. The selection of the compacted sample values for summation includes the values for the most perceptually important channels.

The quantization of the consolidated compacted sample values may be achieved by letting a consolidated compacted sample value that has a value greater than a threshold take a first value and by letting a consolidated compacted sample value that has a value less than or equal to the threshold take a second value.

The threshold may be dependent upon a statistical measure for the consolidated compacted sample values.

As an example, a sampling grid 120 may be determined as follows: Consolidated compacted sample values are determined:

$${Z}_{2} [ k , f ] = {\sum }_{i = 0}^{M - 1} Z [ i , k , f ] \qquad ( 7 A )$$

where Z is a three-dimensional matrix referencing the compacted sample values using a channel index i, a sample index k and a frame index f and where Z₂ is a consolidated compacted sample value.

In Equation (7A), the 3D representation Z of the compacted sample values is converted to a 2D representation Z₂ of consolidated compacted sample values by, for each sample index k and frame index f, summing respective contributions across channels from the 3D matrix Z[i,k,f].

The consolidated compacted sample values are used to emphasize the fact that it is the overall contribution that is perceptually important not the contributions for individual channels.

In some embodiments of the invention, the 2D representation Z₂ of the consolidated compacted sample values may be determined by combining contributions from only a subset of channels. The channels used for determination of the 2D representation Z₂ may be selected e.g. as the channels that are considered as the most important ones (irrespective of the signal content in the channels) or as the channels that, based on the current signal content, can be considered perceptually most important (e.g. channels that introduce certain percentage of the overall energy of the audio scene, channels that have an energy level meeting a predetermined criteria).

The consolidated compacted sample values are quantized. This may be achieved by letting a consolidated compacted sample value that has a value greater than a threshold take a first value and by letting a consolidated compacted sample value that has a value less than or equal to the threshold take a second value.

W=T−min(T)

T=|fftshift(Z₂)|

mn=2·median(|Z₂|) (7B)

The threshold mn is dependent upon a statistical measure for the consolidated compacted sample values. The operators min( ) and median( ) return the minimum and the median values of the consolidated compacted sample values, respectively.

The fftshift( ) function operates on the 2D representation Z₂ to swap the first quadrant (top-left) with the third quadrant (bottom-right) and the second quadrant (top-right) with the fourth quadrant (bottom-left) of the input matrix. The quadrant swapping is not necessary but simplifies subsequent processing when the zero-frequency component is transferred to the middle of the spectrum. Thus, in some embodiments of the invention, quadrant swapping may be omitted.

The quantized sampling grid s_grid 120 may be then specified according to following pseudo-code

| | |
|---|---|
| 1 | R = rows(W ) |
| 2 | C = columns(W ) |
| 3 | |
| 4 | for i = 0 to R |
| 5 | for j = 0 to C |
| 6 | if W(i,j) > mn |
| 7 | s_grid(i,j) = 1 |
| 8 | Else |
| 9 | s_grid(i,j) = 0 |
| 10 | End |
| 11 | end |
| 12 | End |

where rows( ) and columns( ) return the number of rows and columns in the specified input matrix, respectively.

Note that line 6 above applies a criteria that determines whether a certain element of the 2D representation Z₂ indicates a significant sample or not.

In this embodiment of the invention, a threshold value corresponding to twice the median value of the 2D representation is applied as the threshold. In other embodiments a different threshold value or a different criterion may be used. Other criteria may include for example a weighted mean or an average of the weighted mean and weighted median.

The sampling grid 120 is then processed as follows

$$1. s\_grid ( \frac{R}{2} + 1 : R - 1 , : ) = 0$$

$$2. s\_grid ( \frac{R}{2} , \frac{C}{2} : C - 1 ) = 0$$

$$3. s\_grid = ifftshift ( s\_grid )$$

$$4. Find nonzero elements of the sampling grid s\_grid . Save the indices corresponding to the nonzero entries of the matrix s\_grid . Store the indices to s\_grid \_ind .$$

In line 1, the lower half of s_grid starting from row index

$$\frac{R}{2} + 1$$

and ending to row index R-1, and covering all columns is set to zero. In line 2, matrix elements in row index

$$\frac{R}{2}$$

and covering column indices from

$$\frac{C}{2}$$

to C-1 are also set to zero. Since the underlying signal is real-valued, only the upper half-plane of the sampling grid is needed. This is the reason for the operations in lines 1 and 2. In line 3, an operation ifftshift( ), which is an inverse operation of the fftshift( ) detailed above, is performed. In embodiments that omit the quadrant swapping, the operation on line 3 is excluded.

The quantized consolidated compacted sample values 122 of the sampling grid 120 indicate the compacted sample values that are selected for further processing.

If the quantized consolidated compacted sample value for a combination of sampling index and frame index has a second value (0), then none of the compacted sample values referenced by the same combination of sampling index and frame index are selected for further processing.

If the quantized consolidated compacted sample value for a combination of sampling index and frame index has a first value (1), then some or all of the compacted sample values referenced by the same combination of sampling index and frame index but by different channel indexes are selected for further processing.

Thus the final sparsely sampled sample values S may be expressed as

$$S [ m ] = \frac{1}{⌊ \sqrt{M \cdot R \cdot C} ⌋} \cdot [ Z [ m , 0 , 0 ] , \\ real ( Z [ m , s\_grid \_ind ] ) , \\ imag ( Z [ m , s\_grid \_ind ] ) ] \qquad ( 8 )$$

In Equation (8), the vector S consists of three components; the dc-component of the matrix Z, the real parts of the matrix elements according to the sampling grid, and the imaginary parts of the matrix elements according to the sampling grid. Furthermore, Equation (8) is repeated for 0≦m<M−1, i.e. across all input channels.

In an embodiment of the invention, the number of components from the 3D matrix Z to be included when determining S is limited to include only a subset of the components. In one embodiment the number of components to be included from each entry is according to

| | |
|---|---|
| 1 | mldx = M − 1 |
| 2 | for k = 0 to M−1 |
| 3 | if eYₖ/eY_{M-1} > 0.8 |
| 4 | mldx = k; |
| 5 | exit for-loop; |
| 6 | end |
| 7 | End |

where

$${eY}_{m} = {\sum }_{r = 0}^{R - 1} {\sum }_{c = 0}^{C - 1} {{Y}_{sorted}^{3 D} [ m , r , c ]}^{2} \qquad ( 9 )$$

is a channel dependent parameter that has perceptual significance. Furthermore, Y^{3D} is re-ordered such that the channels in the matrix are in the decreasing order of importance (in terms of energy levels). The result of this re-ordering operation is stored in Y_{sorted}^{3D}. The corresponding re-ordered channel indexes are stored in sortIdx.

Thus, the number of components to be included from the 3D matrix Z when determining S is dependent on the accumulated energy across frequency bins and analysis frames from a subset of channels divided by the total energy across frequency bins and analysis frames covering all channels. If, for a certain channel index, this ratio exceeds a predetermined threshold, which in this example is set to 0.8, the contributions only from channels of the (re-ordered) input signal up to that index are included using Equation (8). Thus, in this embodiment Equation(s) (5), (7A), and (8) are determined for 0≦m<mIdx+1 and Z is calculated using matrix Y_{sorted}^{3D} instead of Y^{3D} in Equation (5). The variables mIdx and sortIdx_{mIdx+1, . . . ,M-1} are provided to the receiver apparatus 6 as side information.

In a further embodiment,

$$eRef = {\sum }_{m = 0}^{M - 1} {\sum }_{r = 0}^{R - 1} {\sum }_{c = 0}^{C - 1} {{Y}_{sorted}^{3 D} [ m , r , c ]}^{2} \\ eDest = {\sum }_{m = 0}^{mIdx} {\sum }_{r = 0}^{R - 1} {\sum }_{c = 0}^{C - 1} {{Y}_{sorted}^{3 D} [ m , r , c ]}^{2} \\ scale = eRef / eDest \qquad ( 10 )$$

where the scale is provided to the receiver apparatus 6 as side information. For example uniform scalar quantization may be used to quantize scale.

The parameter mIdx describes the number of components from the (re-ordered) 3D matrix Z are extracted using Equation (8), the parameters sortIdx_{mIdx+1, . . . ,M-1} define the zero valued channels in the Y^{3D} matrix and the parameter scale defines the scaling value to maintain constant signal level alignment between successive groups of frames.

FIG. 9A schematically illustrates another example of a receiving device 6 similar to that illustrated in FIG. 1. However, this receiving device 4 is configured to work in combination with the transmitting device 4 illustrated in FIG. 8. This receiving device 6 includes optional post-processing of the recovered sample values 21 by a modified inverse discrete cosine transform (IMDCT) block 108. Furthermore, the sparse recovery block 20 is illustrated in more detail. In addition, particular processing before sparse recover, such as reception and decoding, is not illustrated.

The receiving apparatus 6 receives a plurality of compacted sample values in a format S where each compacted sample value may be identified using a channel index that differentiates between channels, a sampling index that differentiates between sample values and a frame index that differentiates between frames.

The sparse recovery block 20 performs energy de-compaction with respect the channel indexes, the sampling indexes and the frame indexes to create sample values where each sample value may be identified using at least a channel index that differentiates between channels, a sampling index that differentiates between sample values and a frame index that differentiates between frames.

The energy de-compaction comprises performing, at block 104 an inverse discrete Fourier transform (IDFT) with respect to the channel indexes, performing an inverse discrete Fourier transform with respect to the sampling indexes, and performing an inverse discrete Fourier transform with respect to the frame indexes.

The energy de-compaction also comprises performing an inverse discrete cosine transform (IDCT) with respect to the channel indexes, performing an inverse discrete cosine transform with respect to the sampling indexes, and performing an inverse discrete cosine transform with respect to the frame indexes.

In more detail, at the receiving device 6 the following steps are performed:

At an inverse sampling block 102 the following steps are performed:

$${\hat{Y}}^{3 D} [ m , k , f ] = {idft}_{f , k , m} ( ⌊ \sqrt{M \cdot R \cdot C} ⌋ \cdot \hat{Z} ) \\ \hat{Z} [ m , 0 , 0 ] = \hat{S} [ m ] \\ \hat{Z} [ m , s\_grid \_ind ] = \hat{S} [ ( m + 1 ) \cdot mS : ( m + 2 ) \cdot mS - 1 ] + imag \cdot \hat{S} [ ( m + 2 ) \cdot mS : ( m + 3 ) \cdot mS - 1 ] \\ mS = \{ \begin{matrix}M , \\ mIdx + 1 ,\end{matrix} \qquad ( 11 )$$

alternative embodiment where mIdx is provided as side information
where the variable imag indicates imaginary component and idft_{m,k,f}( ) function calculates one-dimensional inverse DFT in each specified dimension; in this case f, k, and m dimensions. In addition, Equation (11) is repeated for 0≦m<M−1 or alternatively for 0≦m<mIdx+1 (in which case the matrix Ŷ^{3D} is re-ordered to the original channel order using the information (sortIdx_{mIdx+1, . . . ,M-1}) about the zero valued channels in the matrix).

Furthermore, the one-dimensional inverse DFT of a vector X (of length N) is calculated, using a three dimensional inverse discrete Fourier transform (3D-IDFT) block 106, for example according to

$$x [ k ] = {\sum }_{n = 0}^{N - 1} ( X [ n ] \cdot {e}^{j \cdot {w}_{k} \cdot n} )$$

where x={x_{0, . . . , x}_{N-1}} is the IDFT transformed sequence.

According to an embodiment outlined in Equation (10), scaling is applied to maintain constant signal level alignment according to

Ŷ^{3D}=Ŷ^{3D}·scalê (12)

where scalê is the scaling value as described in equation (10) or an approximation thereof.

The 3D plane samples are then converted to frequency domain samples using a three-dimensional inverse discrete cosine transform block 104 as follows

\hat{X}ₘ[k,f]=idct_{m,k,f}(Ŷ^{3D}) (13)

where idct_{m,k,f}( ) denotes one-dimensional inverse DCT in each specified dimension; in this case m, k, and f dimensions. Furthermore, the one-dimensional inverse DCT of a vector X (of length N) is calculated for example according to

$$x [ k ] = {\sum }_{n = 0}^{N - 1} C ( n ) \cdot X ( n ) \cdot cos [ \frac{π \cdot n}{2 \cdot N} \cdot ( 2 \cdot k + 1 ) ] \\ C ( i ) = \{ \begin{matrix}\frac{1}{\sqrt{2}} , & i == 0 \\ 1 , & otherwise\end{matrix} \qquad ( 14 )$$

where x={x₀, . . . x_{N-1}} is the IDCT transformed sequence.

The frequency domain samples are then transformed to time domain signals \hat{x}ₘ via inverse TF block 108, in this case via IMDCT block 108 for example as follows

$${xx}_{m} [ k , l ] = \frac{2}{N} \cdot w [ k ] \cdot {\sum }_{n = 0}^{\frac{N}{2} - 1} {\hat{X}}_{m} [ n , l ] \cdot cos ( \frac{2 \cdot π}{N} \cdot ( k + \frac{N}{4} + 0.5 ) \cdot ( n + 0.5 ) ) , \\ 0 \leq k < N - 1 \\ {\hat{x}}_{m} [ k + l \cdot T ] = {xx}_{m} [ k , l ] + {xx}_{m} [ \frac{N}{2} + k , l - 1 ] , \\ 0 \leq k < \frac{N}{2} \qquad ( 15 )$$

In a further embodiment as illustrated in FIG. 9B, the sparse recovery block 20 is enabled using a minimum L1 norm reconstruction. The reconstruction algorithm solves the L1 problem ∥x−Φy∥₂²+λ∥y∥₁ where x is the sampled audio scene and y is the frequency domain signal, Φ is the sparse sampling function, and λ is the non-zero error that is allowed for the reconstruction algorithm. The implementation of the reconstruction algorithm could be based on various implementation alternatives such as greedy algorithms or basis pursuit. Further details may be found in Blumensath, T.; Davies, M. E.; “Gradient Pursuits”, IEEE Transactions on Signal Processing, Volume 56, Issue 6, June 2008, Pages: 2370-2382 and Van Den Berg, E. and Friedlander, M. P; “Probing the Pareto frontier for basis pursuit solutions”. SIAM J. Sci. Comp. 31, 2, 2008, Pages: 840-912.

A communication device may have functionality that enables it to operate as the transmitting device 4 and as the receiving device 6.

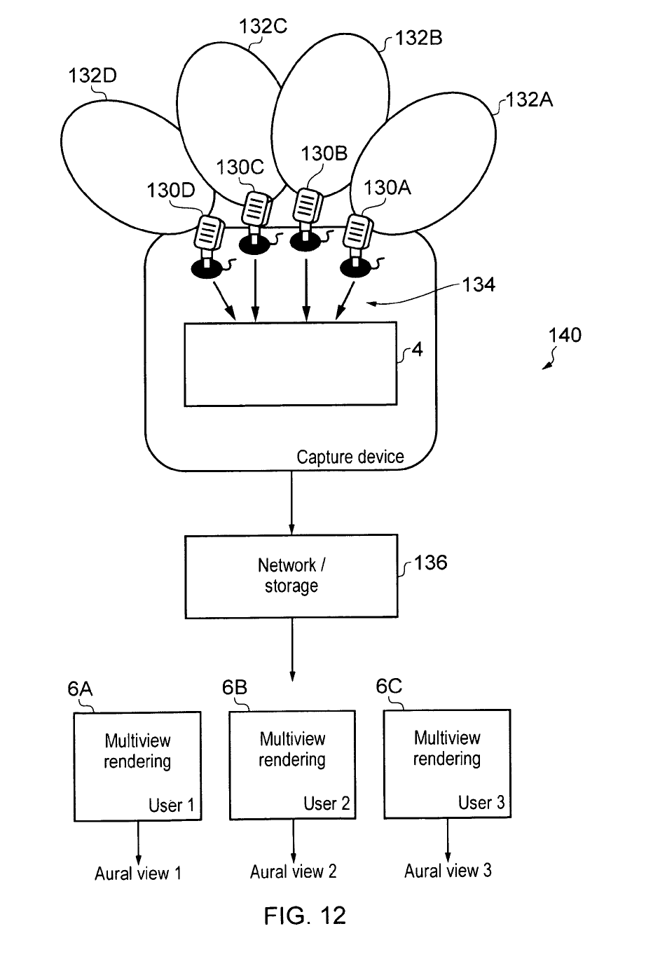

FIG. 12 schematically illustrates a multi-channel audio signal processing system 140 In this example it is a multiview audio capture and rendering system.

In this example framework, multiple, closely spaced microphones 130 are set-up pointing toward different angles relative to a forward axis. Each microphone therefore has a different polar pattern 132. The microphones are used to record an audio scene. The captured signals are processed by transmitting device 4 as described previously and then transmitted (or alternatively stored at storage 136 for later consumption) to the receiving devices 6 at the rendering side. At a receiving device 6 an end user can select the aural view based on his/her preference from the multiview audio transmission and the receiving device 6 is then provided with signal that correspond to the selected aural view. The sparse sampling technique described above is used to meet the bandwidth constraints of the network and/or reduce required storage space.

Despite using multiview audio as an example above, note that the technique may be used to any multi-channel audio, not just multiview audio in order to meet the bit-rate and/or quality constraints. Thus, the technique may be used for, for example “traditional” two-channel stereo audio signals, binaural audio signals, 5.1 or 7.2 channel audio signals, etc.

Note that a microphone set-up that is different from the one shown in the example of FIG. 12 may be used. Examples of different microphone set-ups include “traditional” multichannel (such as 4.0, 5.1, or 7.2 channel configuration), “traditional” multi-microphone set-up with multiple microphones placed close to each other on linear axis, multiple microphones set on a surface of a sphere or a hemisphere according to a desired pattern/density, set of microphones placed in random (but known) positions.

The sparse sampling technique enables, for example, the provision of a high number of input channels to an end user at high quality at reduced bit-rate. When applied to a multiview audio application or system, it enables the end user to select different aural views from audio recording that contains multiple aural views.

In alternative embodiments, a similar multi-channel video signal processing system may be provided where the microphone 130 are replaced by cameras.

Any of the apparatus or devices described such as transmitting device 4 or receiving device 6 may be provided as a module or as an end product. Any of the blocks described may be provided as a module. As used here ‘module’ refers to a unit or apparatus that excludes certain parts/components that would be added by an end manufacturer or a user.

The blocks illustrated in the Figs may represent steps in a method and/or sections of code in the computer program 84. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1-57. (canceled)

58. A method comprising
receiving sample data for a plurality of channels, wherein the sample data comprises a plurality of separate sample values and each sample value may be identified using at least a channel index that differentiates between channels and a sampling index that differentiates between sample values;
performing energy compaction with respect to at least one of the channel indexes and the sampling indexes to create compacted sample values where each compacted sample value may be identified using at least a channel index that differentiates between channels and a sampling index that differentiates between compacted sample values; and
selecting some but not all of the compacted sample values for further processing.

59. A method as claimed in claim 58, further comprising:
selecting a sub-set of the sample indexes;
selecting compacted sample values for further processing using the selected sub-set of sample indexes.

60. A method as claimed in claim 58, further comprising:
selecting a sub-set of the sample indexes;
for each selected sample index, selecting multiple channel indexes; and
selecting compacted sample values for further processing using the selected sample indexes and channel indexes.

61. A method as claimed in claim 60, wherein the multiple channel indexes are selected channel indexes.

62. A method as claimed in claim 58, wherein selection of a compacted sample value is dependent upon a cumulative energy over multiple channels for the sample index of the compacted sample value.

63. A method as claimed in claim 62, wherein the multiple channels are selected channels.

64. A method as claimed in claim 58, wherein energy compaction comprises concentration of energy to a sub-set of a plurality of indexes.

65. A method as claimed in claim 58, wherein energy compaction comprises performing a discrete cosine transform.

66. An apparatus comprising at least one processor and at least one memory, the memory including computer program code, the memory and the computer program code configured to, with the processor, cause the apparatus to perform at least the following:
store sample data for a plurality of channels, wherein the sample data comprises a plurality of separate sample values and each sample value may be identified using at least a channel index that differentiates between channels and a sampling index that differentiates between sample values;
perform energy compaction with respect to at least one of the channel indexes and the sampling indexes to create compacted sample values where each compacted sample value may be identified using at least a channel index that differentiates between channels and a sampling index that differentiates between compacted sample values; and
select some but not all of the compacted sample values for further processing.

67. An apparatus as claimed in claim 66, wherein the memory and the computer program code are further configured to, with the processor, cause the apparatus to perform at least the following: provide selected ones of the compacted sample values for further processing.

68. A computer program product comprising at least one computer-readable storage medium having computer-executable program code portions stored therein, the computer-executable program code portions comprising program instructions configured to:
access sample data for a plurality of channels, wherein the sample data comprises a plurality of separate sample values and each sample value may be identified using at least a channel index that differentiates between channels and a sampling index that differentiates between sample values;
perform energy compaction with respect to at least one of the channel indexes and the sampling indexes to create compacted sample values where each compacted sample value may be identified using at least a channel index that differentiates between channels and a sampling index that differentiates between compacted sample values; and
select some but not all of the compacted sample values for further processing.

69. A method comprising
receiving a plurality of compacted sample values in a format where each compacted sample value may be identified using at least a channel index that differentiates between channels and a sampling index that differentiates between compacted sample values; and
performing energy de-compaction with respect to at least one of the channel indexes and the sampling indexes to create sample values where each sample value may be identified using at least a channel index that differentiates between channels and a sampling index that differentiates between sample values.

70. A method as claimed in claim 69, wherein energy de-compaction comprises distribution of energy from a sub-set of a plurality of indexes.

71. A method as claimed in claim 69, wherein energy de-compaction comprises performing an inverse discrete cosine transform.

72. A method as claimed in claim 69, wherein energy de-compaction comprises performing an inverse discrete Fourier transform followed by a inverse discrete cosine transform.

73. A method as claimed in claim 69, further comprising receiving a plurality of compacted sample values in a format where each compacted sample value may be identified using a channel index that differentiates between channels, a sampling index that differentiates between compacted sample values and a frame index that differentiates between frames; and
performing energy de-compaction with respect the channel indexes, the sampling indexes and the frame indexes to create sample values where each sample value may be identified using at least a channel index that differentiates between channels, a sampling index that differentiates between sample values and a frame index that differentiates between frames.

74. A method as claimed in claim 73, wherein energy de-compaction comprises performing an inverse discrete cosine transform with respect to the channel indexes, performing an inverse discrete cosine transform with respect to the sampling indexes, and performing an inverse discrete cosine transform with respect to the frame indexes.

75. A method as claimed in claim 74, wherein energy compaction further comprises, before performing the inverse discrete cosine transforms, performing an inverse discrete Fourier transform with respect to the channel indexes, performing an inverse discrete Fourier transform with respect to the sampling indexes, and performing an inverse discrete Fourier transform with respect to the frame indexes.

76. An apparatus comprising at least one processor and at least one memory, the memory including computer program code, the memory and the computer program code configured to, with the processor, cause the apparatus to perform at least the following:
receive a plurality of compacted sample values in a format where each compacted sample value may be identified using at least a channel index that differentiates between channels and a sampling index that differentiates between compacted sample values; and
perform energy compaction with respect to at least one of the channel indexes and the sampling indexes to create sample values where each sample value may be identified using at least a channel index that differentiates between channels and a sampling index that differentiates between sample values.

77. A computer program product comprising at least one computer-readable storage medium having computer-executable program code portions stored therein, the computer-executable program code portions comprising program instructions configured to:
access compacted sample values where each compacted sample value may be identified using at least a channel index that differentiates between channels and a sampling index that differentiates between compacted sample values; and
perform energy de-compaction with respect to at least one of the channel indexes and the sampling indexes to create sample values where each sample value may be identified using at least a channel index that differentiates between channels and a sampling index that differentiates between sample values.
